(19) United States
(12) Patent Application Publication
(10) Pub. No.: US 2008/0199032 A1
(43) Pub. Date: Aug. 21, 2008

(54) Loudspeaker enclosure with cylindrical compression chamber and tapered triangular folded horn terminating in an extended triangular bell.

(76) Inventor: Joseph Donald Woelfel, Ithaca, NY (US)

Correspondence Address: Joseph Woelfel, 8 Asbury Drive, Ithaca, NY, 14850, US

(21) Appl. No.: 11/676,291

(22) Filed: Feb. 18, 2007

(51) Int. Cl. H04R 1/02

(52) U.S. Cl. 381/337

(57) ABSTRACT

A loudspeaker enclosure with a cylindrical compression chamber to which an electro-dynamic loudspeaker is mounted at the front. The rear of the cylindrical compression chamber is faired to the front of a tapered triangular pipe with a slot to connect the air column in the cylinder to the air column in the triangular tapered pipe. A baffle inside the tapered triangular pipe splits the tapered pipe into two triangular pipes, effectively increasing the length of the triangular air column substantially. This tapered triangular air column expands into an extended triangular bell and then the room.

### REFERENCES CITED

| | | |
|---|---|---|
| 1,407,574 | Feb. 21, 1922 | Price |
| 1988250 | Jan. 15, 1935 | Olson |
| 6,625,291 | Sep. 23, 2003 | Mohler |
| 6,571,909 | Jun. 3, 2003 | Olinger |
| 5,123,500 | Jun. 23, 1992 | Malhoit |
| 4,558,762 | Dec. 17, 1985 | Carlsson |
| 2,224,919 | Dec. 7, 1940 | Olson |
| 2310243 | Feb. 9, 1943 | Klipsch |
| 4,249,037 | Feb. 3, 1981 | Dexter |
| 1,477,554 | Dec. 18, 1923 | Grissinger |
| 6,425,456 | Jul. 30, 2002 | George |
| 2401328 | Jun. 4, 1946 | Ruber, Black |
| 6,675,932 | Jan. 13, 2004 | Manrique, Wathen |
| 6,385,324 | May 7, 2002 | Koppen, Koppen |
| 5,866,858 | Feb. 2, 1999 | Dewey |
| 4819,716 | Apr. 11, 1989 | Dick |
| 4,750,585 | Jun. 14, 1988 | Collings |

Other references:

Olson, Harry M., Music, Physics and Engineering, Dover, 1967, (Revised Edition) pp. 96-97.

Woelfel, J., and N. J. Stoyanoff, (1995) CATPAC: A neural network for qualitative analysis of text, in Woelfel, J., and N. J. Stoyanoff, (1995). Artificial Neural Networks for Advertising and Marketing Research, Amherst, N.Y., RAH Press, pp. 51-70.

### BACKGROUND

Despite a hundred plus years of research, the variables which explain listener satisfaction with loudspeakers are not completely understood. Among the variables typically considered by audio engineers are frequency range, dynamic range, harmonic distortion, intermodulation distortion, Doppler distortion, cabinet resonances, room resonances, enclosure and room reflections and others. Multiple and disparate approaches to loudspeaker design exist and thrive.

Some engineers focus primarily on flat frequency response across the audible frequency range, perhaps because it is among the easiest variables to measure. In order to maximize the frequency response, designers may require a two, three or even four way division of the frequency range, with each subset of the range covered by a different driver/enclosure.

Some designers prefer to suppress the response of loudspeakers in their most efficient frequency range, and rely on the massive power available from high-powered amplifiers to produce a flat frequency response.

Other designers favor the dynamics or “musicality” of the device, and are willing to sacrifice a portion (usually deep bass) of the spectrum to produce a livelier, more “realistic” sound.

Still others prefer to augment the response of loudspeakers in their least efficient ranges (typically bass response) through acoustical means via horns, resonators, ports, transmission lines, acoustic labyrinths or other devices. These devices work by coupling the cone of the loudspeaker to a large column of air, effectively lowering the resonance and increasing the mass of the cone/voicecoil/air column system. In some cases, such as voight-pipe, acoustical labyrinths, transmission line, tapered quarter wave pipes and the like, the rear wave is meant to be absorbed, while in horns and resonators, the rear wave is meant to augment the sound at lower frequencies. These techniques maximize the efficiency of the loudspaker/enclosure system, which allows the use of low powered tube amplifiers, often without feedback circuits.

Some designers pay particular attention to distortions due to the enclosure itself. These designers rely on non parallel enclosure panels, interior baffles, sound insulation on the inside and outside of the enclosure and other mechanisms to reduce standing waves, vibrations and reflections.

The fact that all these approaches continue to thrive indicates clearly that a consensus about the optimal configuration for a loudspeaker does not exist.

Careful analysis of professional reviews of high-end loudspeakers can offer important insights into this problem. Analyses of several hundred reviews of high end loudspeakers utilizing an advanced neural text analysis system (Catpac II) discovered the following results:

Two, three and four way systems, with crossover networks, are often reported to improve the accuracy of the sound, but reduce the immediacy and reality. Phase errors introduced by the crossover networks and between various drivers in the system reduce imaging and stereo effects. Careful engineering can overcome or at least ameliorate these difficulties, but corrections for these effects are often expensive, and highly rated full range multi-way speaker systems tend to be extraordinarily expensive.

An attractive alternative is to develop single speaker solutions which eliminate the need for crossover networks and other filters. Since large cones are inherently incapable of producing and dispersing very high frequencies, the most common approach is to utilize small cones and augment their low frequencies by acoustic means.

Transmission line, acoustical labyrinth and similar designs control the back wave of loudspeakers, but do not augment bass sufficiently to provide full range response from single small cone systems.

Horn loudspeakers, including exponential, conical, hyperbolic, “tractrix” and others, produce lively, exciting and “realistic” sounding loudspeakers with outstanding dynamic range and realism, but also often produce objectionable “horn” colorations and effects. These are the result of standing waves, edge effects and enclosure resonances resulting from compromises in enclosure design necessitated by simplifications required by the manufacturing process and the need to “fold” the horns into acceptably small and attractive cabinetry for the home. Successful horn loudspeakers also tend to be large, difficult to construct, expensive and unattractive. They tend also to be complicated, some having as many as 70 parts.

Many of the problems of horn enclosures are a result of current standard practice, and can be corrected.

Much of the coloration of horn designs results from standing waves introduced into the enclosure by parallel sides. Most horn enclosures are four sided (or six sided, considering top and bottom panels), and even those which introduce curves into the design remain basically four sided. Indeed, some of the best and most expensive curved horns retain two parallel sides.

The present invention is a folded horn enclosure which maximizes the positive attributes of the horn, such as lively, exciting, realistic sound, while minimizing the negative attributes, such as coloration, standing waves, vibration, complexity and expensive construction. Specifically:

It is an object of this invention to produce an enclosure that maximizes the low frequency response of the speaker.

It is an object of this invention to design an enclosure to avoid coloration by minimizing back wave reflections.

It is an object of this invention to provide an enclosure that eliminates standing waves within the enclosure, thereby preventing box coloration.

It is an object of this invention to minimize reflections from the enclosure.

It is an object of this invention to produce a rigid enclosure that minimizes vibration.

It is an object of this invention to produce an enclosure that maximizes the efficiency of corner loading.

It is an object of this invention to produce an enclosure that is simple and inexpensive to produce.

### SUMMARY OF THE INVENTION

This loudspeaker is a single-driver design, in which the rear of the cone is coupled to an expanding triangular column of air which is coupled to the air in the listening room through an extended triangular bell. As in all horns, this results in lowering the resonant frequency of the cone/voicecoil/air column system, increasing bass response both through its increased mass and through radiation of low frequency sound through the bell of the horn.

While there are thousands of ways to fold a horn, the method proposed by this invention surmounts the problems of existing horn designs in several ways.

First, its tapered triangular design and cylindrical compression chamber have no parallel surfaces, thus preventing the formation of standing waves, an important source of horn colorations.

Second, the interface of the compression chamber to the slot in the acute angle of the triangular horn and the tapered baffle that is not parallel to the cone eliminates reflections of the rear wave back to the cone.

Third, the rounded leading edge of its triangular horn, coupled with the cylindrical form of the compression chamber, virtually eliminate the typical front baffle from the loudspeaker, eliminating any possibility of reflections or “echoes” from the enclosure back to the listener.

Fourth, the internal baffle provides a source of great structural rigidity to the forward facing sides of the enclosure, helping to reduce enclosure vibrations. Overall, the triangular structure of the cabinet provides great structural rigidity and freedom from vibration.

Fifth, the triangular horn offers much simpler construction and dramatically reduces manufacturing costs as compared to the difficulties of manufacturing curved surfaces, especially in wood, which is particularly appropriate for musical instruments and loudspeakers. It completely eliminates the need for plastic in the construction, a material which has poor acoustic properties.

Sixth, the speaker is designed to scale easily, so that it can accommodate drivers of most standard sizes, from a minimum of four inches to large enclosures housing cones of 15″ or even greater diameter.

Seventh, the shape of the enclosure lends itself well to corner placement, which enhances speaker performance, particularly in the bass region, while minimizing intrusive effects in the room.

Eighth, the speaker is visually attractive, unlike the typical high-end loudspeaker.

Ninth, the enclosure is very simple, consisting of only 10 parts.

### BRIEF DESCRIPTION OF THE DRAWINGS

FIG. 1 is a perspective view of the loudspeaker enclosure

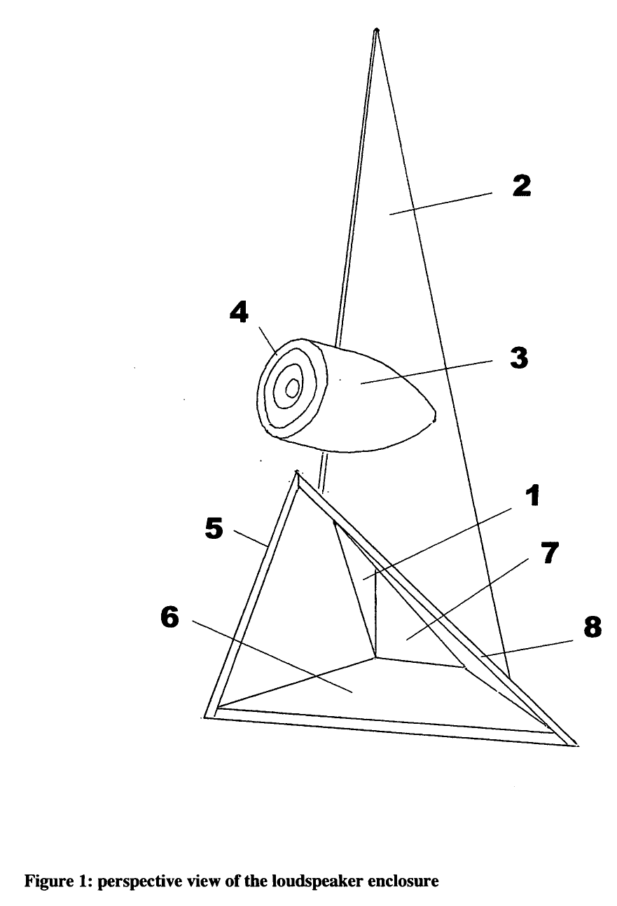

FIG. 2. is a front view of the loudspeaker enclosure

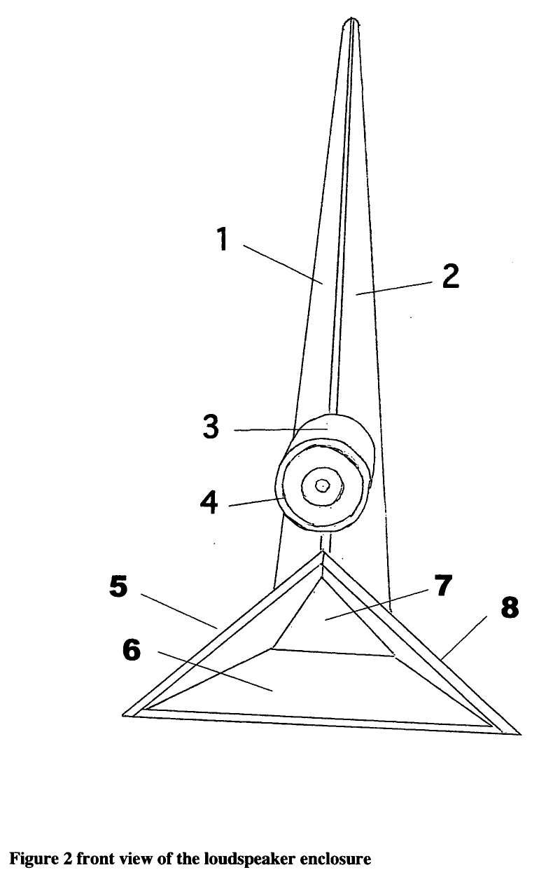

FIG. 3. is a top view of the loudspeaker enclosure

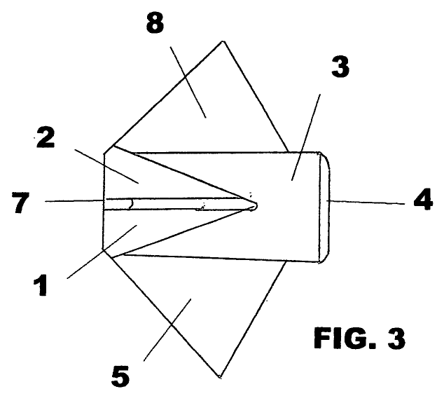

FIG. 4. is a cutaway side view of the louspeaker enclosure showing the interior baffle and baffle end plug.

### DETAILED DESCRIPTION OF THE INVENTION

The loudspeaker enclosure which comprises the invention, herein also referred to as the enclosure, consists of a compression cylinder 3, and a front speaker baffle 4 to which a loudspeaker is mounted. The compression cylinder 3 is notched at the rear to fit securely to the hom, consisting of a left horn side 1, a right horn side 2 and a horn back 7. The horn is attached to an extended bell consisting of the bell left side 5, the bell bottom 6, and the bell right side 8.

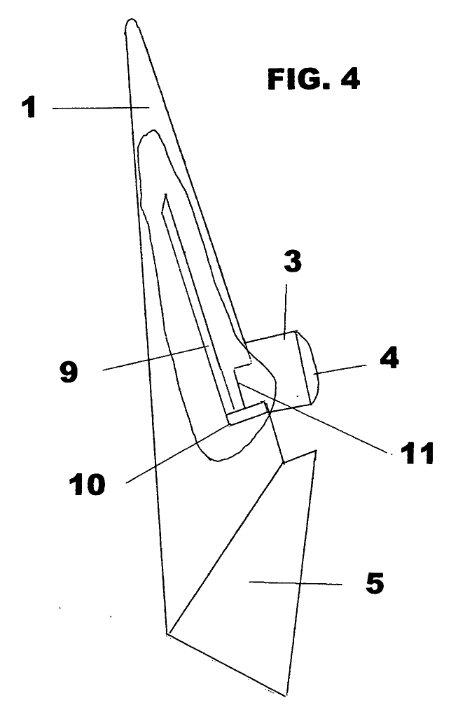

FIG. 4, a cutaway side view of the enclosure, shows the interior baffling consisting of a baffle, 9, and a baffle end plug 10.

The rear sound wave of the speaker is compressed in the compression cylinder 3, and enters the horn through the notch 11 cut into the front of the horn. It is directed by the interior baffling upward to the apex of the horn, then downward to exit the horn into the bell, then exits the bell into the room.

While most rear-loaded loudspeaker enclosures are generally classified as one of several types, e.g., transmission line, acoustical labyrinth, exponential, conical, hyperbolic, catenoid or tractrix horn, etc., in fact, virtually all realizations of loudspeaker enclosures depart from the exact form. Most exponential horn designs, for example, actually consist of a series of conical sections which together combine to form a nearly exponential rate of flare on the average. Even very expensive horns which claim nearly perfect correspondence to the theoretical expansion rate of the horn only do so for part of the horn length, and typically depart very significantly from theory when coupling the typically four-sided horn to the three-sided room corner.

My research with several realizations of the invention has shown that variations in the length of the baffle 9 and the location of the end plug 10, and the angular orientation of the baffle 9 inside the horn of fairly substantial amounts (approximately 40%) do not yield differences in sound perceptible to the listener. These variations can change the classification of the type of horn, and realizations could be considered conical, exponential, hyperbolic, catenoid, tractrix, or even a horn with a tube at the throat and a bell at the mouth as described by Olson (1967, pp. 96-97) to an order of approximation. These parameters (the length of the baffle 9, the location of the end plug 10, the size and shape of the slot 11) remain areas of refinement of the invention.

The enclosure described herein is specifically intended to be scalable, capable of being realized in different sizes for different applications, so no specific dimensions are presented. Different size realizations may indicate the advantage of reasonable adjustments in the exact shape of the horn and bell, as well as adjustments to the rate of flare, and these small modifications should be considered within the scope of the invention. Such modifications may be considered within the spirit of the invention and the scope of the claims and modifications, adaptations and changes may be made without departing from the spirit and claims of the invention.

What is claimed is:

1. A loudspeaker enclosure comprising: a cylindrical compression chamber to which an electro-dynamic loudspeaker is mounted at the front. The rear of the cylindrical compression chamber is faired into a vertical tapered triangular pipe. A slot in the tapered triangular pipe allows the sound from the compression chamber to enter the tapered triangular pipe. A baffle directs the sound wave to the apex of the tapered triangular pipe at the top, then down to the bottom, where it enters an extended triangular bell, then exits into the room.

2. The loudspeaker of claim one wherein all panels and the cylindrical compression chamber are made of plywood or other suitable material.

3. The loudspeaker of claim one consisting of a left horn side, a right horn side, a horn back, an interior baffle, an interior baffle end cap, a left bell side, a right bell side, a bell bottom, a compression cylinder, a front speaker baffle and interior sound insulation stuffing.
